(19) United States
(12) Patent Application Publication
(10) Pub. No.: US 2008/0290591 A1
(43) Pub. Date: Nov. 27, 2008

(54) Static eliminator of sheet handling device

(75) Inventor: You Shimizu, Tsukuba-shi (JP)

Correspondence Address: BIRCH STEWART KOLASCH & BIRCH, PO BOX 747, FALLS CHURCH, VA, 22040-0747, US

(73) Assignee: KOMORI CORPORATION

(21) Appl. No.: 12/153,247

(22) Filed: May 15, 2008

(30) Foreign Application Priority Data
May 22, 2007 (JP) 2007-134924
Mar. 28, 2008 (JP) 2008-085239

(51) Int. Cl. H05F 3/00

(52) U.S. Cl. 271/208

(57) ABSTRACT

A static eliminator, provided in a sheet-fed printing press for doing printing on a sheet of paper, and equipped with static electricity removing devices for removing static electricity building up in the sheet, comprises: electrostatic sensors for detecting the amount of static electricity of the sheet; a display/selector having a display section for indicating information to an operator, and a selection section for selecting whether control over the static electricity removing devices is exercised or not; and a control device for controlling the display/selector so as to indicate the information in the display section of the display/selector, and also controlling the static electricity removing devices, based on the information from the electrostatic sensors.

### BACKGROUND OF THE INVENTION

1. Field of the Invention

This invention relates to a static eliminator which is provided in a sheet handling device for handling a sheet, and is adapted to eliminate static electricity building up in the sheet. The static eliminator is effective, particularly, when provided in a sheet-fed printing press for performing printing on a sheet, and applied in eliminating static electricity building up in the sheet.

2. Description of the Related Art

In a sheet-fed printing press which performs printing on a sheet, for example, if static electricity occurs in the sheet and builds up there, poor sheet-feeding or poor sheet-delivery may be caused during printing. Thus, a static eliminator, for example, is known which feeds ions from an ion generating means onto a feeder board for feeding stacked sheets sequentially, thereby neutralizing the static electricity building up in the sheet for static elimination (see, for example, JP-A-2004-168506).

With the static eliminator described in the above JP-A-2004-168506, however, the sheets on the feeder board are always fed with a certain amount of ions, thus posing the following problems: If the sheet without static electricity is fed, the sheet is electrically charged. If the sheet with a large amount of static electricity is fed, on the other hand, the sheet cannot be fully neutralized for static elimination.

Such problems are not limited to a sheet-fed printing press which performs printing on a sheet. They can similarly occur, for example, in a static eliminator of a sheet handling device, which performs handling, such as printing, coating, or inspection, on a sheet-shaped material, for example, a sheet of paper (may be simply referred to as “sheet”) or a resin film, the sheet handling device including a coating device for coating varnish or the like on sheets sequentially fed from their stack, or an inspection device for inspecting the surface state, etc. of resin films sequentially fed from their stack.

### SUMMARY OF THE INVENTION

The present invention has been accomplished in light of the above-described problems. It is an object of the invention to provide a static eliminator of a sheet handling device, which can reliably eliminate static electricity of a sheet.

A first aspect in accordance with the present invention is a static eliminator of a sheet handling device, which is provided in the sheet handling device for handling a sheet, and is equipped with static electricity removing means for removing static electricity building up in the sheet, comprising: static electricity amount detecting means for detecting an amount of static electricity of the sheet; and control means for controlling display means to indicate information, based on an output from the static electricity amount detecting means.

A second aspect in accordance with the present invention is a static eliminator of a sheet handling device, which is provided in the sheet handling device for handling a sheet, and is equipped with static electricity removing means for removing static electricity building up in the sheet, comprising: static electricity amount detecting means for detecting an amount of static electricity of the sheet; and control means for controlling warning means so as to issue a warning when the amount of static electricity detected by the static electricity amount detecting means is equal to or larger than a reference value.

According to a third aspect of the present invention, the static eliminator of a sheet handling device may further comprise selection means for selecting whether control over the static electricity removing means by the control means is exercised or not.

According to a fourth aspect of the present invention, the static eliminator of a sheet handling device may further comprise a plurality of the static electricity removing means and a plurality of the static electricity amount detecting means, and the control means may control the display means to indicate the information, based on the outputs from the static electricity amount detecting means.

According to a fifth aspect of the present invention, the display means may indicate warning information corresponding to each of the static electricity amount detecting means, and the control means may control the display means so as to indicate the warning information of the static electricity amount detecting means having detected a value, which is equal to or larger than a reference value, among the amounts of static electricity detected by the static electricity amount detecting means.

According to a sixth aspect of the present invention, the display means may indicate a location of disposition of each of the static electricity amount detecting means.

A seventh aspect in accordance with the present invention is a static eliminator of a sheet handling device, which is provided in the sheet handling device for handling a sheet, and is equipped with static electricity removing means for removing static electricity building up in the sheet, comprising: static electricity amount detecting means for detecting an amount of static electricity of the sheet; and control means for controlling the static electricity removing means based on an output from the static electricity amount detecting means.

According to an eighth aspect of the present invention, the control means may control the static electricity removing means such that the static electricity removing means is actuated when the amount of static electricity detected by the static electricity amount detecting means is equal to or larger than a reference value.

According to a ninth aspect of the present invention, the control means may adjust a static electricity removing force of the static electricity removing means in accordance with the output from the static electricity amount detecting means.

According to a tenth aspect of the present invention, the static electricity removing means may be equipped with humidifying means for humidifying an atmosphere in surroundings of the sheet handling device, and the control means may control the humidifying means based on the output from the static electricity amount detecting means.

According to an eleventh aspect of the present invention, the control means may control the humidifying means such that the humidifying means is actuated when the amount of static electricity detected by the static electricity amount detecting means is equal to or larger than a reference value.

According to a twelfth aspect of the present invention, the static electricity removing means may be equipped with an ion generator for feeding ions to neutralize static electricity building up in the sheet for static elimination.

According to a thirteenth aspect of the present invention, the static electricity removing means may be equipped with humidifying means for humidifying an atmosphere in surroundings of the sheet handling device.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows is a general schematic configurational drawing of a sheet-fed printing press including a first embodiment of a static eliminator of a sheet handling device according to the present invention when the static eliminator is applied as a static eliminator of the sheet-fed printing press;

FIG. 2 shows an explanation drawing of a screen of a display/selector of the static eliminator shown in FIG. 1;

FIG. 3 shows an action flow chart of the static eliminator shown in FIG. 1;

FIG. 4 shows an action flow chart showing actions succeeding the actions in FIG. 3;

FIG. 5 shows an action flow chart of a second embodiment of a static eliminator of a sheet handling device according to the present invention when the static eliminator is applied as a static eliminator of the sheet-fed printing press; and

FIG. 6 shows an action flow chart showing actions succeeding the actions in FIG. 5.

### DETAILED DESCRIPTION OF THE INVENTION

### First Embodiment

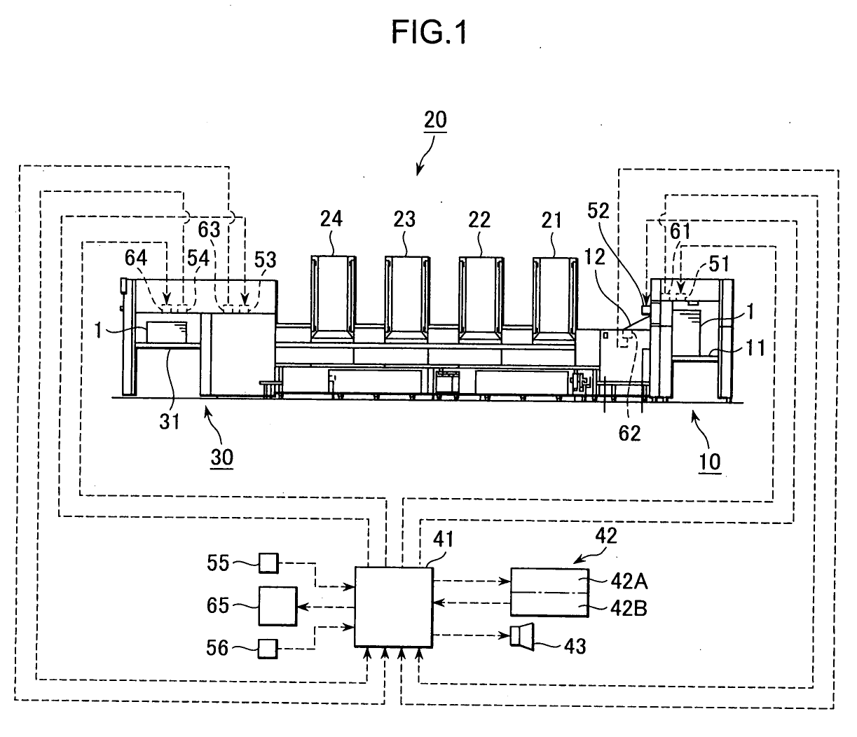

A first embodiment of a static eliminator of a sheet handling device according to the present invention will be described with reference to FIGS. 1 to 4.

As shown in FIG. 1, a feeder 10, which is a sheet supply section, is equipped with a sheet feed rest 11 bearing sheets (i.e., sheets of paper) 1, and a feeder board 12 which is a sheet supply means for sequentially feeding the sheets 1 stacked on the sheet feed rest 11 to a printing section 20.

The feeder board 12 of the feeder 10 communicates via a swing arm shaft pregripper (not shown) with an impression cylinder of a first printing unit 21 of the printing section 20, the first printing unit 21 including an inking device, a dampening device, a plate cylinder, the impression cylinder, etc. (none of them are shown). The impression cylinder of the first printing unit 21 communicates via a transfer cylinder (not shown) with an impression cylinder of a second printing unit 22 of the printing section 20, the second printing unit 22 including an inking device, a dampening device, a plate cylinder, the impression cylinder, etc. (none of them are shown). The impression cylinder of the second printing unit 22 communicates via a transfer cylinder (not shown) with an impression cylinder of a third printing unit 23 of the printing section 20, the third printing unit 23 including an inking device, a dampening device, a plate cylinder, the impression cylinder, etc. (none of them are shown). The impression cylinder of the third printing unit 23 communicates via a transfer cylinder (not shown) with an impression cylinder of a fourth printing unit 24 of the printing section 20, the fourth printing unit 24 including an inking device, a dampening device, a plate cylinder, the impression cylinder, etc. (none of them are shown). The impression cylinder of the fourth printing unit 24 communicates with a delivery section 30 which is a sheet delivery section.

The delivery section 30 is equipped with a delivery rest 31 for delivering the printed sheet 1, a plurality of gripper bars (not shown), attached to a chain running between the impression cylinder of the fourth printing unit and the delivery rest 31, for receiving the sheet 1 from the impression cylinder and delivering it onto the delivery rest 31, and a suction wheel (not shown) which is a speed reducing means for sucking the trailing edge of the sheet 1 delivered from the gripper bars onto the delivery rest 31 to reduce the speed of the sheet 1 so that the sheets 1 will be delivered and arranged in alignment on the delivery rest 31.

In the feeder 10, moreover, there are disposed an electrostatic sensor 51 which is a static electricity amount detecting means for detecting the amount of static electricity of the sheets 1 stacked on the sheet feed rest 11 (i.e., a supply pile), and a static electricity removing device (ion generator) 61 which is a static electricity removing means for feeding ions to the sheets 1 stacked on the sheet feed rest 11 to neutralize static electricity building up in the sheets 1 for static elimination. There are also disposed an electrostatic sensor 52 which is a static electricity amount detecting means for detecting the amount of static electricity of the sheet 1 fed on the feeder board 12, and a static electricity removing device (ion generator) 62 which is a static electricity removing means for feeding ions to the sheet 1 fed on the feeder board 12 to neutralize static electricity building up in the sheet 1 for static elimination.

In the delivery section 30, there are disposed an electrostatic sensor 53 which is a static electricity amount detecting means for detecting the amount of static electricity of the sheet 1 sucked by the suction wheel, and a static electricity removing device (ion generator) 63 which is a static electricity removing means for neutralizing static electricity building up in the sheet 1 sucked by the suction wheel for the purpose of static elimination. There are also disposed an electrostatic sensor 54 which is a static electricity amount detecting means for detecting the amount of static electricity of the sheets 1 delivered onto the delivery rest 31 (i.e., a delivery pile), and a static electricity removing device (ion generator) 64 which is a static electricity removing means for neutralizing static electricity building up in the sheets 1 delivered onto the delivery rest 31 for the purpose of static elimination.

The static electricity removing devices 61 to 64 can generate either positive ions or negative ions, or generate positive ions and negative ions alternately or simultaneously, thereby neutralizing the positively or negatively charged sheet 1 for static elimination. Since the sheet 1 is usually charged positively, it is preferred that the static electricity removing devices 61 to 64 be able to generate negative ions, or generate positive ions and negative ions alternately or simultaneously.

The electrostatic sensors 51 to 54 are electrically connected to the input section of a control device 41 which is a control means. The static electricity removing devices 61 to 64 are electrically connected to the output section of the control device 41. A temperature sensor 55 which is a temperature detecting means for detecting the temperature of an atmosphere in the surroundings of the sheet-fed printing press, and a humidity sensor 56 which is a humidity detecting means for detecting the humidity of the atmosphere in the surroundings of the sheet-fed printing press are also electrically connected to the input section of the control device 41. A humidifier 65, which is a humidifying means for humidifying the atmosphere in the surroundings of the sheet-fed printing press (especially, the surroundings of the places where the electrostatic sensors 51 to 54 are disposed) and is also a static electricity removing means, is also electrically connected to the output section of the control device.

A display/selector 42 including a display section 42A which is a display means for indicating information to an operator, and a selection section 42B which is a selection means for selecting whether control over the static electricity removing devices 61 to 64 by the control device 41 is exercised or not, is electrically connected to the input section and the output section of the control device 41. A speaker 43, which is a warning means for warning the operator, is also electrically connected to the output section of the control device 41.

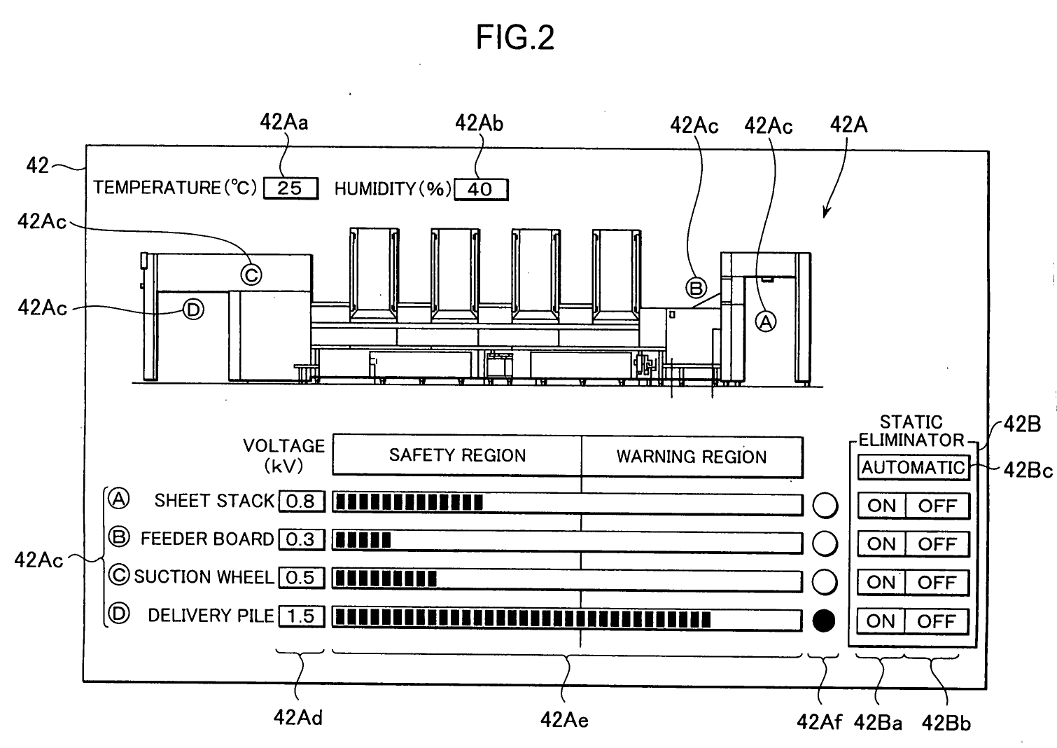

The display/selector 42 is furnished with a touch panel for displaying the display section 42A and the selection section 42B on the same screen, as shown in FIG. 2. This touch panel is provided with, as the display section 42A, a temperature display portion 42Aa for indicating the temperature of the atmosphere in the surroundings of the sheet-fed printing press based on information on the results of detection by the temperature sensor 55, a humidity display portion 42Ab for indicating the humidity of the atmosphere in the surroundings of the sheet-fed printing press based on information on the results of detection by the humidity sensor 56, a sensor position display portion 42Ac for indicating the positions of installation of the electrostatic sensors 51 to 54 disposed in the sheet-fed printing press, a static electricity amount display portion 42Ad and a graph display portion 42Ae for indicating the amounts of static electricity, detected by the electrostatic sensors 51 to 54, by values and graphs, respectively, and a color tone display portion 42Af for indicating, in a color tone, the state of charge (whether in a safety region or in a warning region) at the position of detection of each of the amounts of static electricity of the sheets 1 detected by the electrostatic sensors 51 to 54.

The touch panel is provided with, as the selection section 42B, ON-switches 42Ba for actuating the humidifier 65 and also actuating the static electricity removing devices 61 to 64 independently of each other, OFF-switches 42Bb for stopping the operation of the humidifier 65 and also stopping the operation of the static electricity removing devices 61 to 64 independently of each other, and an automatic operation switch 42Bc for automatically performing the actuation and stoppage of the static electricity removing devices 61 to 64 and the humidifier 65.

The control device 41 is designed to be capable of controlling the display/selector 42 so as to indicate various pieces of information on the display section 42A of the display/selector 42, and controlling the speaker 43 so as to issue a warning, based on outputs (information) from the sensors 51 to 56. The control device 41 is also designed to be capable of controlling the operation of the static electricity removing devices 61 to 64 and the humidifier 65, based on the operating state of the static electricity removing devices 61 to 64 selected by the selection section 42B of the display/selector 42, various pieces of information (outputs) from the sensors 51 to 56, and various pieces of information inputted beforehand (details will be offered later)

In the present embodiment, the feeder 10, the feeder board 12, the printing section 20, and the delivery section 30, which perform the supply, transport, printing, speed reduction, and delivery of the sheet 1, each constitute the sheet handling device. Also, the sheet-fed printing press as a whole, which includes the feeder 10, the feeder board 12, the printing section 20, and the delivery section 30, constitutes the sheet handling device.

The actions of the sheet-fed printing press according to the present embodiment will be described below.

The sheets 1 placed on the sheet feed rest 11 of the feeder 10 are sequentially passed, one by one, from the feeder board 12 on to the impression cylinder of the first printing unit 21 of the printing section 20, where the sheet 1 is printed in a first color. Then, the sheet 1 is passed on to the impression cylinder of the second printing unit 22, where it is printed in a second color. Similarly, the sheet 1 is sequentially passed on to the impression cylinders of the third printing unit 23 and the fourth printing unit 24, where it is printed in a third color and a fourth color. Then, the sheet 1 is gripped by the gripper bar of the delivery section 30, and the sheets 1 are transported while being gripped by the gripper bars. Finally, the sheets leach have the trailing edge sucked by the suction wheel, whereby the sheets 1 are sequentially delivered onto the delivery rest 31 while being arranged in alignment.

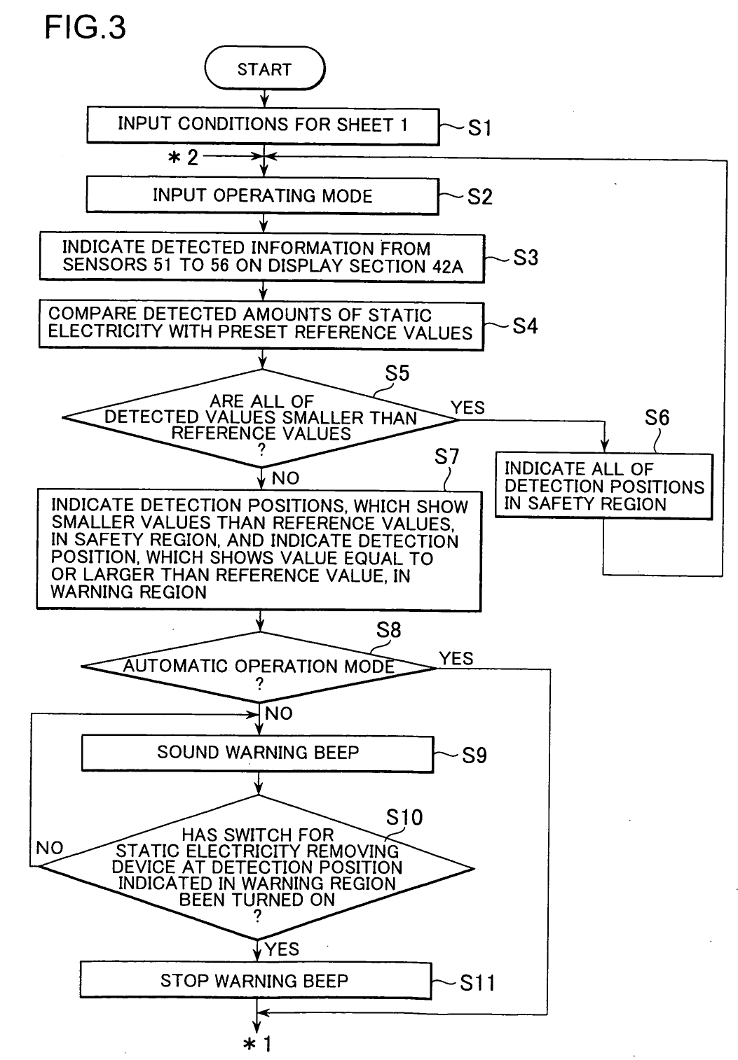

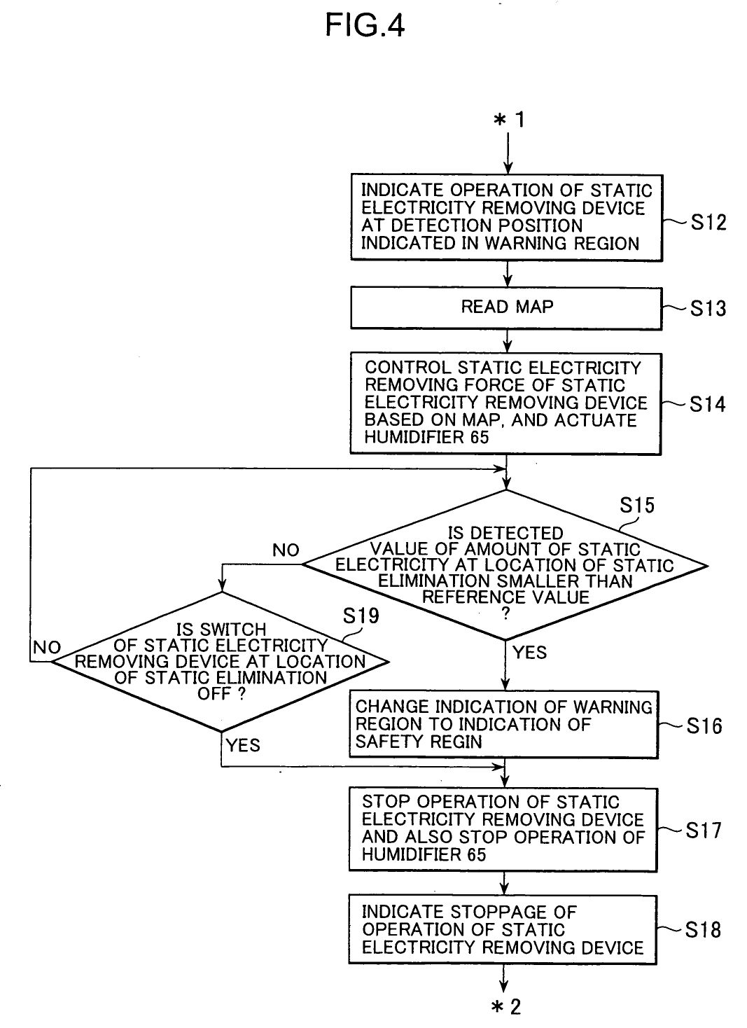

In performing printing on the sheet 1 in the above-mentioned manner, the first step is to select and input the conditions of the sheet 1, such as type, size, and thickness, into the control device 41 (Step S1), as shown in FIGS. 3 and 4. Also, an operating mode (whether the actuation and stoppage of the static electricity removing devices 61 to 64 and the humidifier 65 are performed automatically or manually) is selected from the selection section 42B of the display/selector 42 and inputted into the control device 41 (ON-OFF setting of the automatic operation switch 42Bc) (Step S2).

In response, the control device 41 indicates the temperature and humidity of the atmosphere in the surroundings of the sheet-fed printing press on the temperature display portion 42Aa and the humidity display portion 42Ab of the display section 42A of the display/selector 42, based on outputs (information) from the temperature sensor 55 and the humidity sensor 56, and also indicates the amounts of static electricity, which are possessed by the sheets 1 on the sheet feed rest 11 and the feeder board 12 of the feeder 10, the sheet 1 sucked by the suction wheel of the delivery section 30, and the sheets 1 on the delivery rest 31 of the delivery section 30, on the display portions 42Ad to 42Af corresponding to the respective positions of the display section 42A of the display/selector 42, based on outputs (information) from the electrostatic sensors 51 to 54 (Step S3).

Then, the control device 41 compares the amounts of static electricity at the respective static electricity detection positions, which have been detected by the electrostatic sensors 51 to 54, with allowable static electricity amounts (reference values) inputted and set beforehand for the static electricity amount detection positions in accordance with the conditions of the sheet 1, such as type, size and thickness (Step S4).

Generally, in the sheet-fed printing press, the reference values set for the delivery section 30 may be relatively large values enough to arrange the sheets 1 in alignment, whereas the reference values set for the feeder 10 are set at relatively small values so that the sheets 1 can be fed sequentially, one by one, without being fed overlappingly.

If the amounts of static electricity detected at all the static electricity amount detection positions are smaller than the corresponding reference values (Step S5), the control device 41 controls the display section 42A of the display/selector 42 to indicate each of the spots of the color tone display portion 42Af at all the detection positions in the safety region (for example, a green color) (Step S6). Then, the program returns to Step S2, followed by repeating Steps S2 to S5.

If, in Step S5, not all of the amounts of static electricity detected at all the static electricity amount detection positions are smaller than the reference values, namely, if the amount of static electricity detected at one or more of the static electricity amount detection positions is equal to or larger than the reference value, the control device 41 controls the display section 42A of the display/selector 42 to indicate the spots of the color tone display portion 42Af corresponding to the detection positions, where the values are smaller than the reference values, in the safety region (for example, a green color), and to indicate the spot of the color tone display portion 42Af corresponding to the detection position, where the value is not smaller than the reference value, in the warning region (for example, a red color) (Step S7).

If, in Step S2, the automatic operation mode has not been selected (Step S8), namely, if the manual operation mode has been selected (the automatic operation switch 42Bc is OFF (not lit)), the speaker 43 sounds a warning beep (alarm) (Step S9), requiring the operator to select the actuation of any of the static electricity removing devices 61 to 64 corresponding to the static electricity amount detection position indicated in the warning region by the graph display portion 42Ae and the color tone display portion 42Af of the display section 42A of the display/selector 42.

If, in response, the operator turns on the ON-switch 42Ba of the selection section 42B corresponding to any of the static electricity removing devices 61 to 64 at the static electricity amount detection position indicated in the warning region by the graph display portion 42Ae and the color tone display portion 42Af of the display section 42A of the display/selector 42 (Step S10), the control device 41 stops the sounding of the warning beep (alarm) by the speaker 43 (Step S11). The control device 41 also controls the display/selector 42 to indicate the actuation of any of the static electricity removing devices 61 to 64 at the static electricity amount detection position indicated in the warning region (Step S12). That is, in the selection section 42B, the ON-switch 42Ba is lit, and a map is read in which the relationship between the amount of static electricity charged and the output of any of the static electricity removing devices 61 to 64 necessary and sufficient for static elimination (i.e., static electricity removing force) has been inputted beforehand in correspondence with the conditions, such as type, size and thickness, of the sheet 1 (Step S13). Settings are made based on the map, and the corresponding any of the static electricity removing devices 61 to 64 is controlled, simultaneously with the actuation of the humidifier 65, so as to produce the static electricity removing force (output) corresponding to the value of the amount of static electricity detected by the corresponding any of the electrostatic sensors 51 to 54 (Step S14).

By so doing, the sheet 1 at the detection position indicated in the warning region is sprayed with ions from the corresponding any of the static electricity removing devices 61 to 64 to have its static electricity neutralized for static elimination, and has its ambient atmosphere humidified by the humidifier 65 for static elimination.

In this manner, the sheet 1 at the detection position indicated in the warning region has its static electricity removed. If, as a result, the amount of static electricity of the sheet 1 detected at the static elimination position becomes smaller than the reference value (Step S15), the control device 41 changes the indication of the warning region (e.g., a red color) to the indication of the safety region (e.g., a green color) in the color tone display portion 42Af of the display section 42A of the display/selector 42 (Step S16) based on the information from any of the electrostatic sensors 51 to 54. The control device 41 also stops the operation of any of the static electricity removing devices 61 to 64 concerned, and stops the operation of the humidifier (Step S17). In the selection section 42B of the display/selector 42, the OFF-switch 42Bb of any of the static electricity removing devices 61 to 64 at the static elimination site concerned is pressed to indicate the stoppage of operation (Step S18). That is, in the selection section 42B, the ON-switch 42Ba is turned off. Then, the program returns to Step S2, and repeats Steps S2 to S18.

If, in Step S8, the automatic operation mode has been selected (the automatic operation switch 42Bc is ON (lit)), on the other hand, the control device 41 automatically turns on the ON-switch 42Ba of the selection section 42B corresponding to the static electricity amount detection position indicated in the warning region by the graph display portion 42Ae and the color tone display portion 42Af of the display section 42A of the display/selector 42, and executes Steps S12 to S18 similar to those in the manual operation mode.

Even if, in Step S15, the amount of static electricity of the sheet 1 detected at the static elimination site is larger than the reference value, the OFF-switch 42Bb of any of the static electricity removing devices 61 to 64 corresponding to the static elimination site is turned on (Step S19), whereby the operation of the corresponding any of the static electricity removing devices 61 to 64 and the operation of the humidifier 65 can be forcibly stopped.

In short, in the present embodiment, the charged state (amount of static electricity) of the sheet 1 is always grasped and, depending on the charged state (amount of static electricity) of the sheet 1, static elimination is carried out or not carried out, and the static electricity removing force is adjusted.

In the present embodiment, therefore, the sheet 1 without electrostatic charge is not charged, and even the sheet 1 with a large amount of static electricity can be sufficiently neutralized for static elimination.

Hence, according to the present embodiment, static elimination of the sheet 1 can be performed reliably.

### Second Embodiment

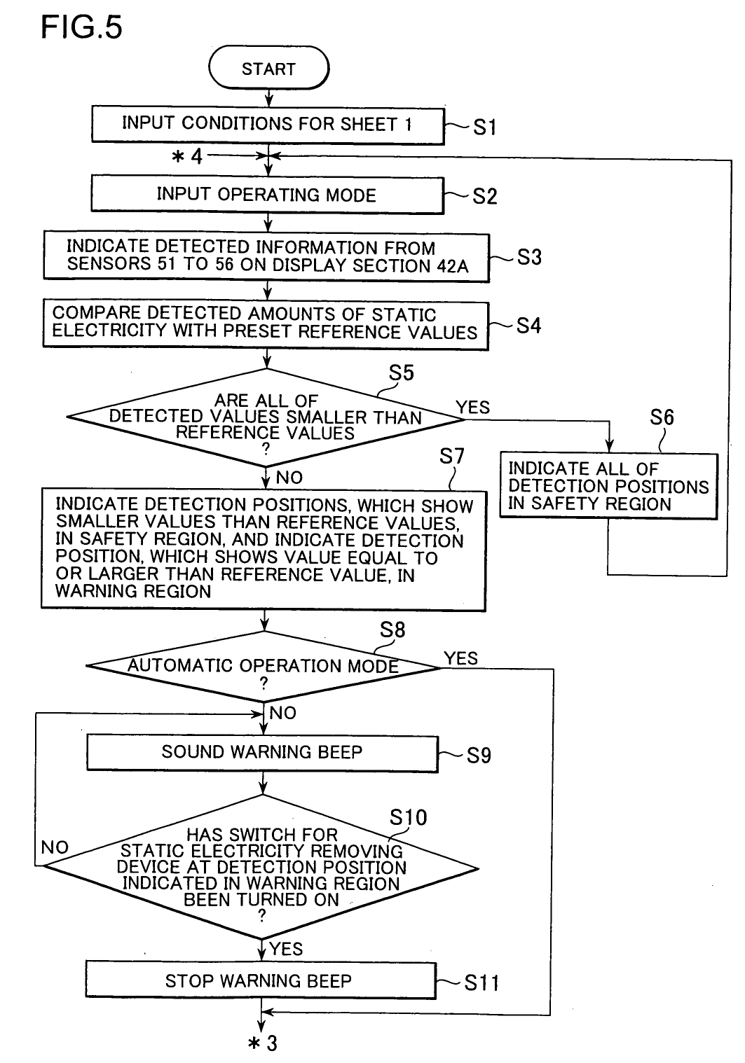

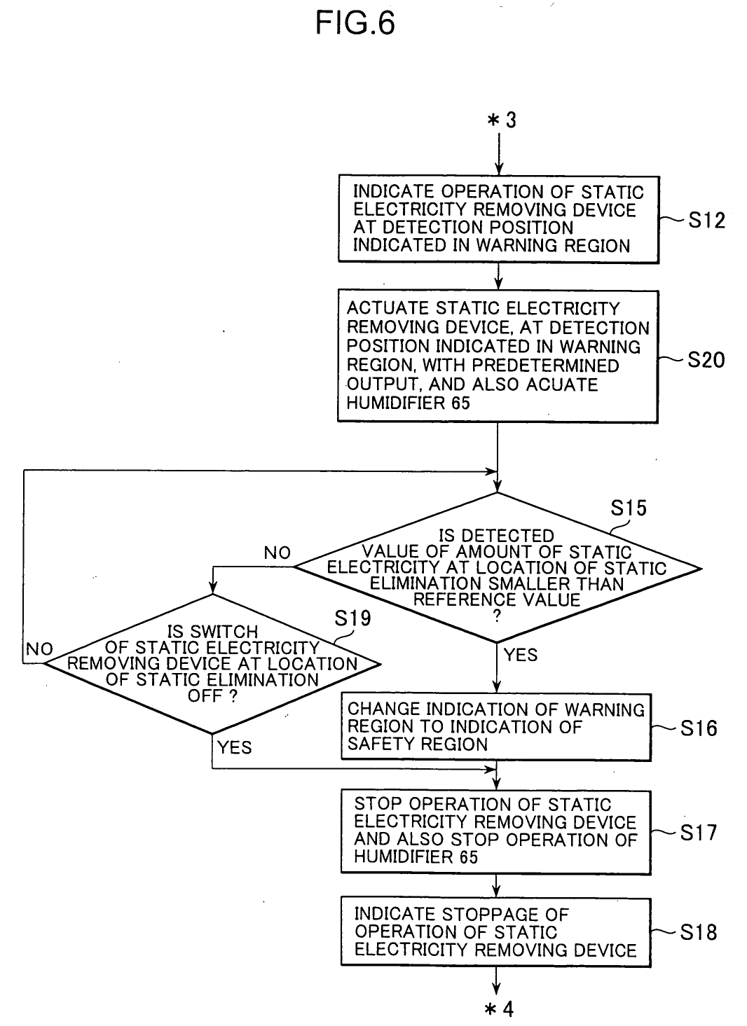

A second embodiment of the static eliminator of a sheet handling device according to the present invention will be described with reference to FIGS. 5 and 6. FIG. 5 shows an action flow chart of the second embodiment of the static eliminator of a sheet handling device according to the present invention when the static eliminator is applied as a static eliminator of a sheet-fed printing press. FIG. 6 shows an action flow chart showing actions succeeding the actions in FIG. 5. The same portions as those in the aforementioned first embodiment are assigned the same reference numerals and symbols as those used in the first embodiment to omit explanations which overlap the explanations in the first embodiment.

The static eliminator according to the present embodiment is the same as that in the first embodiment in terms of the configuration of the apparatus itself, and differs from the latter apparatus only in a part of the action flow.

Concretely, as shown in FIGS. 5 and 6, the control device 41 performs the actions in Steps S1 to S12 described in the aforementioned first embodiment, then actuates corresponding any of the static electricity removing devices 61 to 64 with a predetermined output (static electricity removing force), and also actuates the humidifier 65, namely, actuates any of the static electricity removing devices 61 to 64 at the detection position indicated in the warning region with the predetermined output (static electricity removing force), and also actuates the humidifier 65 (Step S20).

By so doing, the sheet 1 at the detection position indicated in the warning region is sprayed with ions from corresponding any of the static electricity removing devices 61 to 64 to have its static electricity neutralized for static elimination, and has its ambient atmosphere humidified by the humidifier 65 for static elimination, in the same manner as in the first embodiment.

Then, the control device 41 performs the actions in Steps S15 to S19 described in the first embodiment.

That is, in the aforementioned first embodiment, the control device 41 reads, in Step S13, the map in which the relationship between the amounts of static electricity charged and the outputs of the static electricity removing devices 61 to 64 necessary and sufficient for static elimination (i.e., static electricity removing forces) has been inputted beforehand in correspondence with the conditions, such as type, size and thickness, of the sheet 1. In Step S14, the control device 41 makes settings based on the map, and controls the operation of corresponding any of the static electricity removing devices 61 to 64 so as to produce the static electricity removing force (output) corresponding to the value of the amount of static electricity detected by the corresponding any of the electrostatic sensors 51 to 54, and also actuates the humidifier 65. In the present embodiment, by contrast, the control device 41 actuates the corresponding any of the static electricity removing devices 61 to 64 not based on the map, but with a predetermined output, and also actuates the humidifier 65. That is, in Step S20, any of the static electricity removing devices 61 to 64 at the detection position indicated in the warning region is actuated with the predetermined output, and the humidifier 65 is actuated.

Hence, according to the present embodiment, static elimination of the sheet 1 can be performed reliably, as in the aforementioned first embodiment.

### Other Embodiments

In the aforementioned first embodiment, if the value of the amount of static electricity detected by any of the electrostatic sensors 51 to 54 is equal to or larger than the reference value, the humidifier 65 is actuated (Step S14). As an alternative embodiment, it is possible to actuate the humidifier 65, for example, if not only the value of the amount of static electricity detected by any of the electrostatic sensors 51 to 54 is equal to or larger than the reference value, but also the humidity of the atmosphere in the surroundings of the sheet-fed printing press detected by the humidity sensor 56 is not higher than a preset range. It is also possible to stop the operation of the humidifier 65, if the humidity of the atmosphere in the surroundings of the sheet-fed printing press detected by the humidity sensor 56 exceeds the preset range, even when the detected value of the amount of static electricity is equal to or larger than the reference value.

In the above first and second embodiments, when the speaker 43 sounds a warning beep (alarm) if the manual operation mode has been selected, the operator turns on the ON-switch 42Ba of the selection section 42B of the display/selector 42, based on the information from the display section 42A of the display/selector 42. As a result, the control device 41 controls the corresponding any of the static electricity removing devices 61 to 64, and actuates the humidifier 65. As an alternative embodiment, however, it is possible for the operator to directly perform the manual adjustment of the output of the static electricity removing device (ion generator) or the manual actuation of the humidifier, based on the information indicated in the display means or the warning from the warning means.

In the above first and second embodiments, a plurality of the electrostatic sensors, 51 to 54, and a plurality of the static electricity removing devices, 61 to 64, are disposed in the feeder 10 and the delivery section 30. However, the present invention is not limited to such configurations. The locations of disposition, and the number of those instruments disposed are set, as appropriate, depending on various conditions. For example, only one electrostatic sensor and only one static electricity removing device may be disposed in the feeder 10, or a plurality of the electrostatic sensors and a plurality of the static electricity removing devices may be further disposed in the vicinity of each of the impression cylinders of the printing units 21 to 24 of the printing section 20.

In the above first and second embodiments, both the static electricity removing devices (ion generators) 61 to 64 and the humidifier 65 are applied as the static electricity removing means to remove static electricity building up in the sheet 1. As an alternative embodiment, however, it is possible to apply either the static electricity removing devices (ion generators) 61 to 64 or the humidifier 65 as the static electricity removing means to remove static electricity building up in the sheet 1.

In the above first and second embodiments, moreover, the aforementioned pieces of information are composed, including the temperature, the humidity, the sensor position, the amount of static electricity, the graph, and the color tone indicated in the display section 42A of the display/selector 42, as well as the operating state selected and indicated in the selection section 42B of the display/selector 42. However, the present invention is not limited to this mode. The pieces of information need not be composed of all these constituent features, or can be composed further including other constituent features.

In the first and second embodiments, moreover, descriptions have been offered of a case where the present invention is applied to the static eliminator of the sheet-fed printing press for doing printing on the sheet 1. However, the present invention is not limited to this case. For example, the present invention can be applied as in the first and second embodiments, so long as it is applied to a static eliminator of a sheet handling device, which carries out the handling, such as printing, coating or inspection, of a sheet, for example, a sheet of paper or a resin film, examples of the sheet handling device being a coating device for coating varnish or the like on sheets of paper sequentially fed from their stack, and an inspection device for inspecting the surface state, etc. of resin films sequentially fed from their stack.

According to the static eliminator of a sheet handling device concerned with the present invention, the control means controls the display means based on the output from the static electricity amount detecting means. This feature makes it possible to know the sheet without electrostatic charge, or the sheet with a large amount of static electricity. Hence, static elimination of the sheet by the static electricity removing means can be performed reliably.

According to the static eliminator of a sheet handling device concerned with the present invention, moreover, the control means controls the static electricity removing means based on the output from the static electricity amount detecting means. This feature enables the static electricity removing means to remove the static electricity of the sheet in accordance with the charged state of the sheet. Hence, static elimination of the sheet by the static electricity removing means can be performed reliably, regardless of whether the sheet is not electrostatically charged, or the sheet has a large amount of static electricity.

As noted above, the static eliminator of a sheet handling device according to the present invention can reliably eliminate static electricity of a sheet by the static electricity removing means. Thus, this apparatus can be used very advantageously, for example, in the printing industry in which a sheet of paper is printed on.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A static eliminator of a sheet handling device, which is provided in the sheet handling device for handling a sheet, and is equipped with static electricity removing means for removing static electricity building up in the sheet, comprising:
static electricity amount detecting means for detecting an amount of static electricity of the sheet; and
control means for controlling display means to indicate information, based on an output from the static electricity amount detecting means.

2. A static eliminator of a sheet handling device, which is provided in the sheet handling device for handling a sheet, and is equipped with static electricity removing means for removing static electricity building up in the sheet, comprising:
static electricity amount detecting means for detecting an amount of static electricity of the sheet; and
control means for controlling warning means so as to issue a warning when the amount of static electricity detected by the static electricity amount detecting means is equal to or larger than a reference value.

3. The static eliminator of a sheet handling device according to claim 1, further comprising:
selection means for selecting whether control over the static electricity removing means by the control means is exercised or not.

4. The static eliminator of a sheet handling device according to claim 1, further comprising:
a plurality of the static electricity removing means and a plurality of the static electricity amount detecting means, and
wherein the control means controls the display means to indicate the information, based on the outputs from the static electricity amount detecting means.

5. The static eliminator of a sheet handling device according to claim 4, wherein
the display means indicates warning information corresponding to each of the static electricity amount detecting means, and
the control means controls the display means so as to indicate the warning information of the static electricity amount detecting means having detected a value, which is equal to or larger than a reference value, among the amounts of static electricity detected by the static electricity amount detecting means.

6. The static eliminator of a sheet handling device according to claim 5, wherein
the display means indicates a location of disposition of each of the static electricity amount detecting means.

7. A static eliminator of a sheet handling device, which is provided in the sheet handling device for handling a sheet, and is equipped with static electricity removing means for removing static electricity building up in the sheet, comprising:
static electricity amount detecting means for detecting an amount of static electricity of the sheet; and
control means for controlling the static electricity removing means based on an output from the static electricity amount detecting means.

8. The static eliminator of a sheet handling device according to claim 7, wherein
the control means controls the static electricity removing means such that the static electricity removing means is actuated when the amount of static electricity detected by the static electricity amount detecting means is equal to or larger than a reference value.

9. The static eliminator of a sheet handling device according to claim 8, wherein
the control means adjusts a static electricity removing force of the static electricity removing means in accordance with the output from the static electricity amount detecting means.

10. The static eliminator of a sheet handling device according to claim 7, wherein
the static electricity removing means is equipped with humidifying means for humidifying an atmosphere in surroundings of the sheet handling device, and
the control means controls the humidifying means based on the output from the static electricity amount detecting means.

11. The static eliminator of a sheet handling device according to claim 10, wherein
the control means controls the humidifying means such that the humidifying means is actuated when the amount of static electricity detected by the static electricity amount detecting means is equal to or larger than a reference value.

12. The static eliminator of a sheet handling device according to claim 1, wherein
the static electricity removing means is equipped with an ion generator for feeding ions to neutralize static electricity building up in the sheet for static elimination.

13. The static eliminator of a sheet handling device according to claim 2, wherein
the static electricity removing means is equipped with an ion generator for feeding ions to neutralize static electricity building up in the sheet for static elimination.

14. The static eliminator of a sheet handling device according to claim 7, wherein
the static electricity removing means is equipped with an ion generator for feeding ions to neutralize static electricity building up in the sheet for static elimination.

15. The static eliminator of a sheet handling device according to claim 1, wherein
the static electricity removing means is equipped with humidifying means for humidifying an atmosphere in surroundings of the sheet handling device.

16. The static eliminator of a sheet handling device according to claim 2, wherein
the static electricity removing means is equipped with humidifying means for humidifying an atmosphere in surroundings of the sheet handling device.

17. The static eliminator of a sheet handling device according to claim 7, wherein
the static electricity removing means is equipped with humidifying means for humidifying an atmosphere in surroundings of the sheet handling device.
